(19) United States
(12) Patent Application Publication
(10) Pub. No.: US 2022/0305303 A1
(43) Pub. Date: Sep. 29, 2022

(54) FACEPIECE CHIN RETENTION FEATURE

(71) Applicant: 3M INNOVATIVE PROPERTIES COMPANY, St. Paul, MN (US)

(72) Inventors: Darin K. Thompson, Huntersville, NC (US); Judge W. Morgan, III, Oakboro, NC (US); Jeffrey S. Vogus, Monroe, NC (US); Graham P. Wilson, Flintshire (GB); Carl E. Tucker, Old Colwyn (GB)

(21) Appl. No.: 17/610,113

(22) PCT Filed: May 4, 2020
(86) PCT No.: PCT/IB2020/054228

§ 371 Date: Nov. 9, 2021

Related U.S. Application Data
(60) Provisional application No. 62/846,393, filed on May 10, 2019.

(51) Int. Cl. A62B 18/08; A62B 18/02

(52) U.S. Cl. CPC A62B 18/08; A62B 18/02

(57) ABSTRACT

A respiratory mask and a face seal for a respiratory mask, the face seal being configured to maintain a seal against the user's face even when the user moves his/her jaws and/or cheeks. In one embodiment, a respiratory mask comprises a body and a face seal coupled to the body, and the face seal includes a sealing land configured to contact the user's face and a compressible portion extending away from the sealing land. In one embodiment, the face seal further includes a chin retainment element configured to receive at least a portion of the user's chin therein. In one embodiment, the compressible portion is transitionable between an uncompressed first condition and a compressed second condition.

### FIELD

The present technology is generally related to personal protective equipment, and in particular to a face seal for a respirator mask, the face seal having a compressible portion that maintains a seal between the face seal and the user's face even when the user moves his/her jaws or cheeks.

### BACKGROUND

Numerous types of respirators for respiratory protection systems that deliver breathing air and/or filtered breathing air to a user are known. Such respirators have different performance requirements depending on the circumstances in which the devices are intended to be used. Examples of respirators include self-contained breathing apparatus (SCBAs), air purification respirators (APRs), powered air purification respirators (PAPRs), and the like that supply pressurized air, or that filter or cleanse ambient air. Certification agencies set forth different requirements, such as fit factor requirements that correspond to assigned protection factors, for different types of respirators to allow users to select appropriate respirators or respiratory protection equipment for the environments they work in, with respect to contaminants and environmental conditions that warrant varying levels of protection.

### SUMMARY

Respirators typically include a face mask that should properly fit the face of the wearer. The face mask is designed for a particular type of respirator. For example, a face mask for a SCBA may be designed differently than a face mask for an APR or a PAPR. The seal for the face mask may be designed differently for the SCBA than the APR, as the SCBA and APR have different fit factor requirements. The materials of the face mask and/or the seal may be different depending on the type of respirator. As such, a user that must operate in different types of environments to perform different duties may need different face masks for each different respirator. It is costly for users to maintain multiple masks for each type of respirator so that the user can perform different duties. Additionally, having multiple masks may contribute to a logistical burden for the users and problems in inventory control and maintenance costs in that annual fit tests drive the cost of implementing and supporting respiratory protection programs. Furthermore, having different designs for a family of respirator is costly in terms of design costs, tooling costs, manufacturing costs, and the like.

Seal of the face mask is an important feature affecting fit factor. One area of the face mask that is difficult to maintain seal with the user's face is under the user's chin. For example, movement of the user's mouth, such as during talking, causes the user's face to move relative to the seal, which may break the seal. Additionally, because it is inconvenient to attach a strap near the chin area of the mask, the face mask tends to move away from the user's chin area, such as when the user looks down and the weight of the mask pulls the mask away from the user's face. Additionally, some known face masks support canisters or other components that tend to pull the face mask away from the user's face.

Comfort in the fit of the face mask to the face also affects fit factor because if the face mask is not comfortable to wear the face mask will bother and distract the user or may cause painful “hotspots” on the wearers' faces, contributing to undue physiological burden. Additionally, the user may improperly don and tighten the face mask in an attempt to avoid such discomfort. Face masks are typically made in only a very limited number of shapes and sizes, intended for use with a wide variety of facial shapes and sizes in the user population. The varying anthropometric accommodation necessary to support the user population of human faces makes it difficult to provide a mask which will comfortably fit a large population of users. Additionally, these differences also make it difficult to design a mask that remains in contact with and maintains an airtight seal against the user's face when the user moves his/her face, such as jaws and/or cheeks.

The present disclosure generally relates to a respiratory mask and a face seal for a respiratory mask, the face seal being configured to maintain a seal against the user's face even when the user moves his/her jaws and/or cheeks. In one embodiment, a respiratory mask comprises: a body; and a face seal coupled to the body, the face seal including: a sealing land configured to contact a face of a user; and a compressible portion extending away from the sealing land.

In one aspect, the face seal further includes an edge portion configured to receive at least a portion of the body of the respiratory mask.

In one aspect, the face seal further includes a main portion, the main portion including the sealing land. In one aspect, the face seal further includes a chin retainment element, the chin retainment element extending away from the main portion of the face seal and being configured to receive at least a portion of chin of the user.

In one aspect, the sealing land has a free edge, the compressible portion extending away from the sealing land at a location between the free edge and the chin retainment element.

In one aspect, the compressible portion is transitionable between an uncompressed first condition and a compressed second condition, the sealing land being configured to remain in contact with the face of the user when the compressible portion transitions between the uncompressed first condition and the compressed second condition. In one aspect, the compressible portion includes a proximal portion joined to the sealing land, a distal portion opposite the proximal portion, and a middle portion therebetween. In one aspect, the middle portion has a U-shaped cross section with a nadir. In one aspect, the nadir is at a first location relative to the chin retainment element when the compressible portion is in the uncompressed first condition and the nadir is at a second location relative to the chin retainment element when the compressible portion is in the compressed second condition, the second location being farther away from the chin retainment element than the first location.

In one aspect, the compressible portion is U-shaped in cross section.

In one aspect, the compressible portion has a plurality of folds.

In one embodiment, a respiratory mask comprises: a body; and a face seal coupled to the body, the face seal including: a main portion, the main portion including a sealing land configured to contact a face of a user; a chin retainment element extending away from the main portion of the face seal; a compressible portion, the compressible portion having a proximal portion, a distal portion opposite the proximal portion, and a middle portion between the proximal and distal portions, the proximal portion joined to and extending away from the main portion of the face seal, the compressible portion being between the sealing land and the chin retainment element, the compressible portion being transitionable between an uncompressed first condition and a compressed second condition; and an edge portion joined to the distal portion of the compressible portion, the edge portion being configured to receive at least a portion of the body, the edge portion being located a first distance from the main portion of the face seal with the compressible portion is in the uncompressed first condition and a second distance from the main portion of the face seal when the compressible portion is in the compressed second condition, the first distance being greater than the second distance.

In one aspect, the middle portion of the compressible portion has a first direction of curvature and each of the proximal portion and the distal portion of the compressible portion has a second direction of curvature that is opposite the first direction of curvature.

In one aspect, the middle portion of the compressible portion is U-shaped in cross section. In one aspect, the compressible portion has a nadir, the nadir moving away from the chin retainment element when the compressible portion transitions from the uncompressed first condition to the compressed second condition.

In one aspect, the middle portion has a bellows shape.

In one aspect, the sealing land is configured to remain in contact with the face of the user when the compressible portion transitions between the uncompressed first condition and the compressed second condition.

In one aspect, wherein the respiratory mask is configured for use with a self-contained breathing apparatus (SCBA).

In one aspect, the face seal is composed of at least one of silicone rubber, thermoplastic elastomer, and rubber.

In one embodiment, a face seal for a respiratory mask configured to be worn by a user comprises: a main portion, the main portion including a sealing land configured to contact a face of a user; a chin retainment element extending away from the main portion of the face seal; a compressible portion, the compressible portion having a proximal portion, a distal portion opposite the proximal portion, and a middle portion between the proximal and distal portions, the proximal portion joined to and extending away from the main portion of the face seal, the middle portion having a first direction of curvature and each of the proximal portion and the distal portion of the compressible portion having a second direction of curvature that is opposite the first direction of curvature, the compressible portion being between the sealing land and the chin retainment element, the compressible portion being transitionable between an uncompressed first condition and a compressed second condition, the sealing land being configured to remain in contact with the face of the user when the compressible portion transitions between the uncompressed first condition and the compressed second condition; and an edge portion joined to the distal portion of the compressible portion, the edge portion being located a first distance from the main portion of the face seal when the compressible portion is in the uncompressed first condition and a second distance from the main portion of the face seal when the compressible portion is in the compressed second condition, the first distance being greater than the second distance.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front perspective view of a respirator mask having a face seal in accordance with the present disclosure;

FIG. 2 is a front view of an embodiment of the face seal for the respirator mask of FIG. 1 in accordance with the present disclosure;

FIG. 3 is a front perspective partial cross-sectional view of the facepiece shown in FIGS. 1 and 2 in accordance with the present disclosure;

FIG. 4 is a cross-sectional side view of a portion of the facepiece shown in FIGS. 1-3 in accordance with the present disclosure, the facepiece including a chin retainment element and a compressible portion in an uncompressed first condition;

FIG. 5 is a cross-sectional side view of the portion of the facepiece shown in FIG. 4 in accordance with the present disclosure, the facepiece being attached to the body of the respirator mask in accordance with the present disclosure, the compressible portion being in the uncompressed first condition;

FIG. 6 is a cross-sectional side view of the portion of the facepiece shown in FIG. 4 in accordance with the present disclosure, the facepiece being attached to the body of the respirator mask as shown in FIG. 5 and in accordance with the present disclosure, the compressible portion being in the uncompressed first condition;

FIG. 7 is a cross-sectional side view of the portion of the facepiece shown in FIG. 4 in accordance with the present disclosure, the facepiece being attached to the body of the respirator mask as shown in FIG. 5 and in accordance with the present disclosure, the compressible portion being in a compressed second condition; and

FIG. 8 shows another embodiment of the face seal for the respirator mask of FIG. 1 in accordance with the present disclosure.

### DETAILED DESCRIPTION

The present disclosure advantageously provides a respirator mask that includes a face seal having a chin retainment element and a compressible portion. The face seal is configured to physically engage and provide a seal with the user's face, including proximate the user's mouth and cheeks. When the user's jaws and cheeks are moving, the compressible portion of the face seal compresses and uncompresses to provide and maintain a seal against the user's face, despite movement of the user's face. In particular, the face seal of the present disclosure allows the body of the mask to “float” over the user's face without breaking the seal between the user and the mask.

Before describing in detail exemplary embodiments that are in accordance with the disclosure, it is noted that components have been represented where appropriate by convention symbols in drawings, showing only those specific details that are pertinent to understanding the embodiments of the disclosure so as not to obscure the disclosure with details that will be readily apparent to those of ordinary skill in the art having the benefit of the description herein. As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

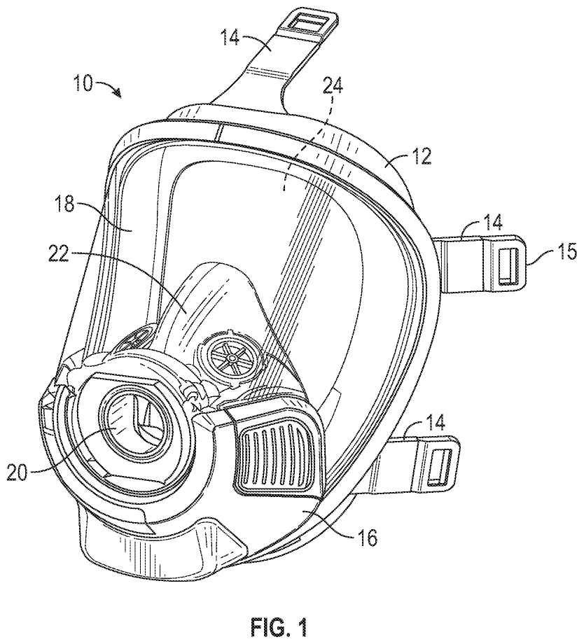

Referring now to the drawing figures in which like reference designations refer to like elements, an embodiment of a respirator mask for providing respiratory protection constructed in accordance with the principles of the invention is shown in the figures and generally designated as “10.” Referring to FIG. 1, the mask 10 is a respirator mask configured to be worn by a user in environments where the user is exposed to hazardous materials, such as, but not limited to, gases, vapors, aerosols (such as dusts, mists, and/or biological agents), and/or the like. The mask 10 includes a face seal 12 having integrated straps 14 with buckles 15. As used herein, the term “integrated” means that the face seal 12 is manufactured to include the straps 14, such as by molding the face seal 12 and straps 14 as a single integrated piece. Thus, the straps 14 are extensions of the main portion 12a of the face seal 12. However, it will be understood that other configurations may also be used, such as wherein the straps are removably coupled to the face seal 12. The mask 10 includes other components, depending on the conditions and purpose for which the mask 10 is used. In one embodiment, the mask 10 generally includes a body 16, a faceplate or fenestra 18 with an aperture 20 to which a respirator can be attached (not shown), and a nosecup 22. In one embodiment, the body 16 defines an interior 24 of the mask 10 and the nosecup 22 and at least a portion of the face seal 12 are located within the interior 24 of the mask 10. As shown herein, the mask 10 is a full mask that covers the user's face, including the user's eyes. However, it will be understood that the mask 10 is not limited to such a configuration, and alternatively may be any other type of mask 10 that is configured to at least partially seal to the user's face, such as an oronasal mask.

The body 16 may be composed of any suitable material(s), such as a rigid or semi-rigid plastic. The face seal 12 may be attached to the mask body such that the face seal 12 is configured to create a seal around at least a portion of the user's face when the mask is worn. In some embodiments the face seal 12, and in one embodiment the straps 14, are composed of a material having a lower durometer than the body 16. As a non-limiting example, the body 16 may be composed of a rigid plastic, such as high-density polyethylene (HDPE), whereas the face seal 12 may be composed of silicone rubber, thermoplastic elastomer (TPE), rubber (natural and/or synthetic), and/or other material(s) that is/are more flexible than the body 16.

The body 16 of the mask 10 includes one or more openings or apertures, such as the aperture 20. Each aperture is configured to receive one or more attachable components (not shown), such as a replaceable filter cartridge, a valve, an air hose, a speech module, and/or the like. The body 16 may include any number of the apertures depending on the particular application of the mask 10 and the number of attachable components that are used.

Although not shown, in some embodiments the mask 10 includes a harness that is configured to hold the mask body 16 on the user's face and thereby hold the mask 10 in position over the user's nose and mouth. In some embodiments, the harness includes a plurality of straps (not shown) that are attached to the mask body 16 and are configured to secure the mask 10 to the user's head. For example, a harness may be coupled to the straps 14 on the face seal 12. However, it will be understood that the harness additionally or alternatively may include any other structure. The harness may be reusable. Optionally, the harness is disposable. The harness is optionally fabricated using materials that are relatively easy to sterilize with relatively common sterilization methods.

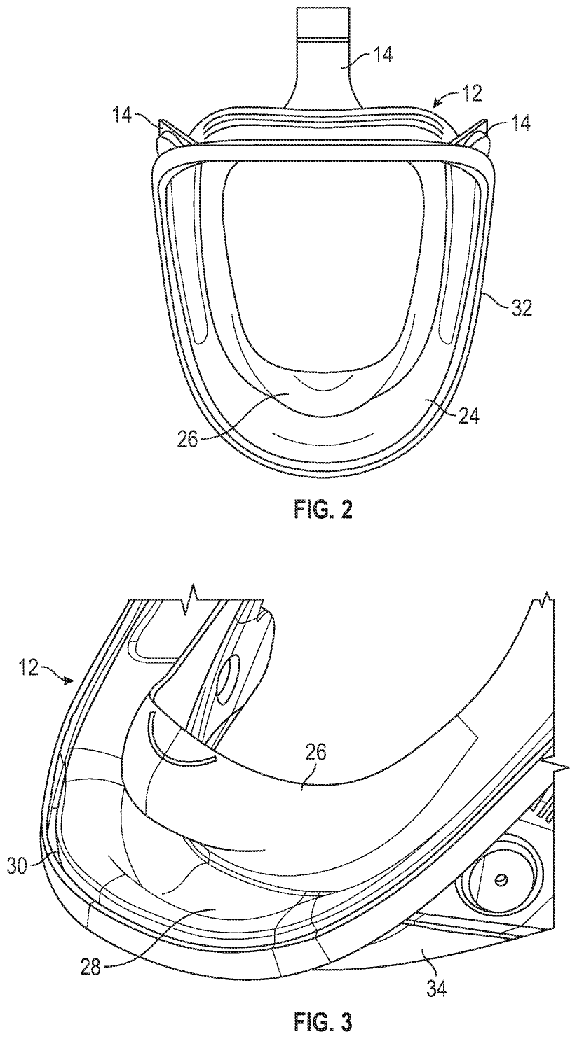

Referring now to FIGS. 2 and 3, the face seal 12 is shown in greater detail. The face seal 12 is configured to at least partially seal the mask against the user's face. As will be described in more detail below, the face seal 12 includes a chin retainment element 26 and a compressible portion 28 proximate the chin retainment element 26. In one embodiment, the face seal 12 also includes an edge portion 30 that is configured to accept at least a portion of an edge or perimeter 32 of the body 16 and/or the fenestra 18 for coupling the face seal 12 to the body 16 and/or the fenestra 18 (for example, as shown in FIGS. 5-7). Additionally or alternatively, the edge portion 30 may be configured to accept, and therefore the face seal 12 being couplable to, at least a portion of one or more other components of the mask 10. In one non-limiting example, the edge portion 30 is folded to define a channel configured to receive at least a portion of one or more components of the mask 10.

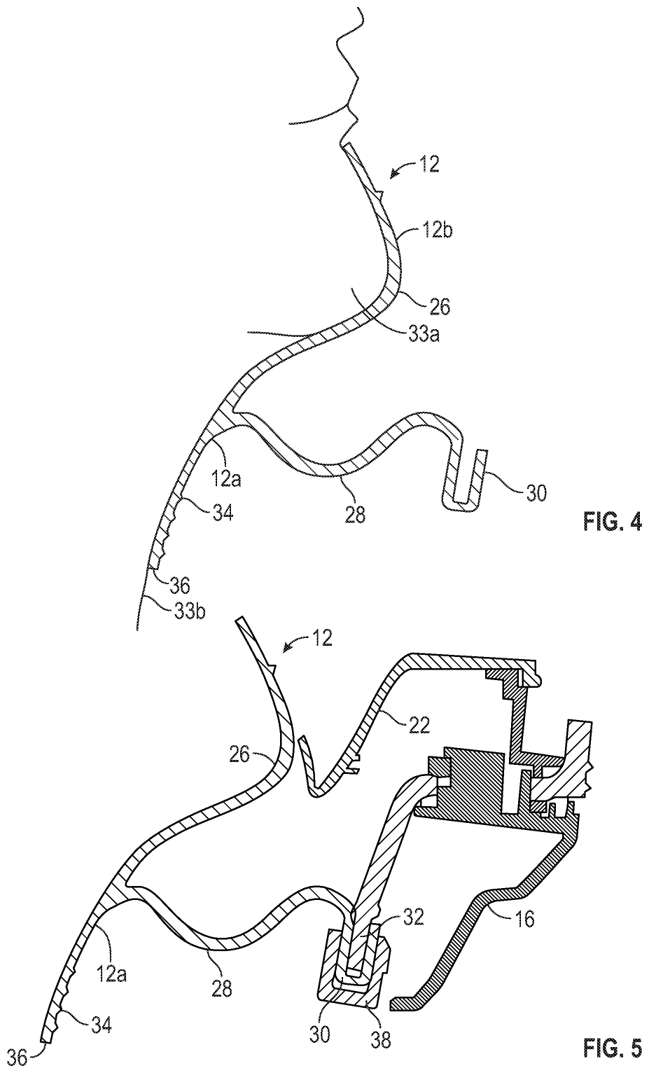

Referring now to FIGS. 4 and 5, cross-sectional views of the portion of the face seal 12 including the chin retainment element 26 and the compressible portion 28 are shown. FIG. 4 shows a portion of the face seal 12 alone, and FIG. 5 shows the portion of the face seal 12 of FIG. 4 coupled to a portion of the mask body 16. In one embodiment, the chin retainment element 26 extends from at least a portion of the face seal 12, such as the portion of the face seal 12 that is proximate the user's chin 33a, face, and/or jaws/neck 33b when worn by the user. The chin retainment element 26 is sized and configured to accept at least a portion of the user's chin 33a therein, and the chin retainment element 26 includes a bottom configured to extend under the chin 33a of the user (for example, as shown in FIG. 4). The face seal 12 may be rolled upward and away from the main portion 12a of the face seal 12 to form a cup-shaped chin retainment element 26 adapted to capture the chin 33a therein. As used herein, the phrase “main portion 12a of the face seal” 12 generally includes the portions of the face seal 12 other than the chin retainment element 26, the compressible portion 28, and the edge portion 30.

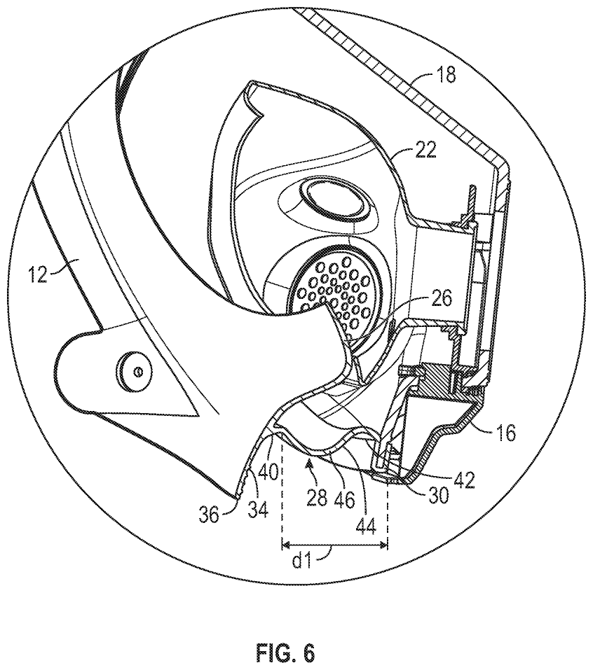

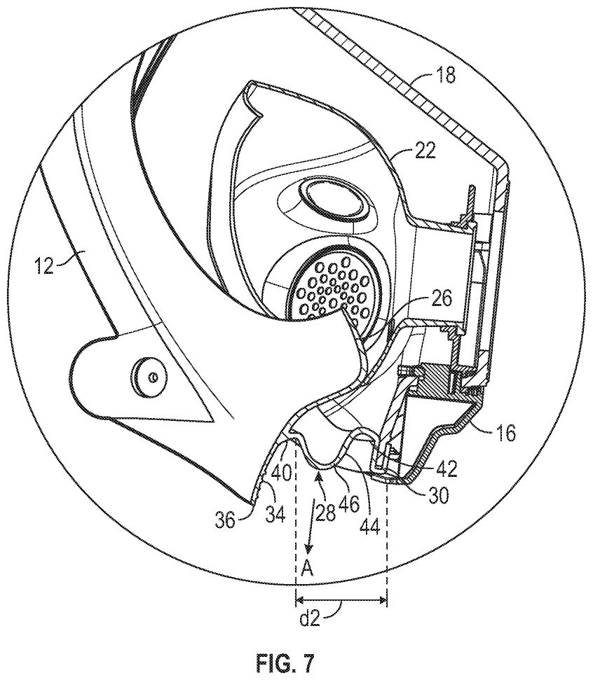

In one embodiment, the face seal 12 also includes a sealing land 34 configured to be in contact with and provide a seal against the user's face and/or neck 33b when the mask is worn. In one embodiment, the sealing land 34 generally extends downward from the chin retainment element 26 (that is, toward the user's neck) when the mask 10 is worn by the user. Further, in one embodiment, the compressible portion 28 generally extends away from the main portion 12a of the face seal 12 at a location between a free edge 36 of the sealing land 34 and the chin retainment element 26 such that the compressible portion 28 is below the chin retainment element 26 and above the free edge 36 of the sealing land 34 when the mask 10 is worn by the user. As is discussed in greater detail below (and shown in FIGS. 6 and 7), the edge portion 30 of the face seal 12 is located a distance from the main portion 12a of the face seal 12 (for example, a distance from both the chin retainment element 26 and the sealing land 34), with the distance being defined by the compressible portion 28. In one embodiment, the distance between the edge portion 30 and the main portion 12a of the face seal 12 (that is, both the chin retainment element 26 and the sealing land 34) is greater when the compressible portion 28 is in an uncompressed first condition than when the compressible portion 28 is in a compressed second condition. As shown in FIG. 5, the edge portion 30 may be secured to the body 16, portion thereof, or other component of the mask 10 by a bezel or securement element 38 configured to at least partially extend over the edge portion 30. Further, in one embodiment, the chin retainment element 26 is proximate a lower portion of the nosecup 22 (also shown in FIGS. 6 and 7).

Referring now to FIGS. 6 and 7, the compressible portion 28 is shown in greater detail. FIG. 6 shows the face seal 12 coupled to a mask body 16 and the compressible portion 28 in an uncompressed first condition. FIG. 7 shows the face seal 12 coupled to the mask body 16, as in FIG. 6, but with the compressible portion 28 being in a compressed second condition. The compressible portion 28 is configured to compress or collapse relative to the main portion 12a of the face seal 12 and includes a proximal portion 40, a distal portion 42, and a middle portion 44 therebetween. In one embodiment, the proximal portion 40 meets and extends outward from the main portion 12a of the face seal 12 at a location between the free edge 36 of the sealing land 34 and the chin retainment element 26. In one embodiment the distal portion 42 meets or is joined to, and in some embodiments defines, the edge portion 30. When in the uncompressed first condition, the compressible portion 28 has a somewhat undulating configuration, with the middle portion 44 having a slight “U” shape or mild curvature that extends downward relative to the chin retainment element 26 (and the user's chin 33a) when the mask 10 is worn by the user. Put another way, the middle portion 44 has a U-shaped cross-sectional shape. The middle portion 44 includes or defines a cup with a nadir 46, and the cup is deeper (that is, the nadir 46 is further from the upper portion of the cup and from the chin retainment element 26) when the compressible portion 28 is in the compressed second condition. Further, in one embodiment, each of the proximal portion 40 and the distal portion 42 includes a mild curvature that is opposite the curvature of the middle portion 44. When in the uncompressed first condition, the compressible portion 28 define a distance d₁ between the edge portion 30 (and, therefore, the area at which the face seal 12 is coupled to the body 16 or other mask component) and the main portion 12a of the face seal 12.

As shown in FIG. 7, when in the compressed second condition, the middle portion 44 of the compressible portion 28 has a more pronounced downward curvature than when in the uncompressed first condition, and the distance d₂ between the edge portion 30 and the main portion 12a of the face seal 12 is less than distance d₁ shown in FIG. 6. Put another way, the compressible portion 28 is compressed and the middle portion 44 is flexed downward away from the chin retainment element 26 to a greater extent (that is, the cup is deeper and the nadir 46 is further from the upper portion of the cup and from the chin retainment element 26) and the edge portion 30 is closer to the user's face. When compressed, the nadir 46 moves in direction A, which is in a direction away from the chin retainment element 26. It will be understood that direction arrows are shown relative to the portion of the mask with which the arrows are associated. Put another way, the nadir 46 is at a first location relative to the chin retainment element 26 when the compressible portion 28 is in the uncompressed first condition and the nadir 46 is at a second location relative to the chin retainment element 26 when the compressible portion 28 is in the compressed second condition, the second location being farther away from the chin retainment element 26 than the first location. This compression may occur when the user moves his/her jaws or cheeks. The compressible portion 28 provides a flexible portion that can absorb or allow for movement and flexion without breaking the seal between the face seal 12 (such as the sealing land 34) and the user's face. Additionally, when compressed, the compressible portion 28 generates an opposite force against the user's face and/or neck 33b that helps maintain the seal between the sealing land 34 and the user's face and/or neck 33b.

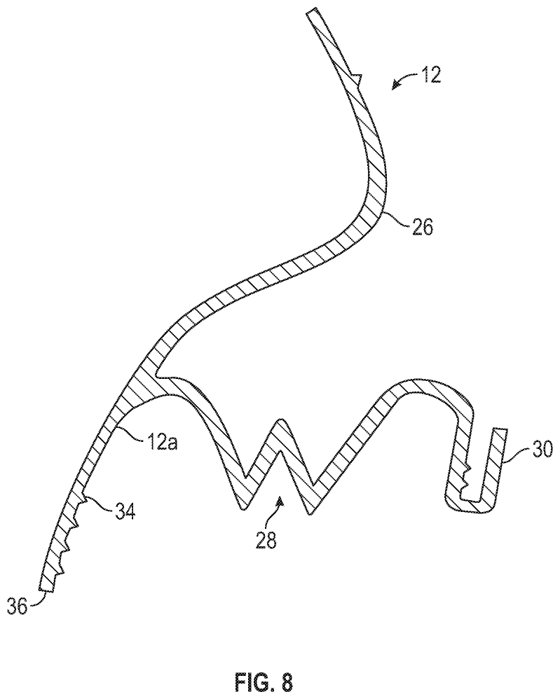

The various design parameters of the various structures of the face seal 12 and the compressible portion 28 such as, but not limited to, the material(s), the amount of flexibility, the dimensions, the shape, the orientation, the position, the location, and/or the like, may be selected to enable the face seal 12 to provide a predetermined seal with the user's face and the compressible portion 28 to move, flex, and become compressed when the user's face moves. In fact, FIG. 7 shows a further non-limiting embodiment of a face seal 12 wherein the compressible portion 28 has an accordion or bellows configuration rather than the undulating configuration shown in FIGS. 4-7. For example, the compressible portion 28 may include one or more pleats or folds. This configuration also allows the compressible portion 28 to compress and flex as the user's face moves without breaking the seal between the face seal 12 and the user's face. It will be understood that the compressible portion 28 may include more or fewer folds than shown in FIG. 8, or may have a compressible configuration other than those shown herein.

In one embodiment, a respiratory mask 10 comprises: a body 16; and a face seal 12 coupled to the body 16, in which the face seal 12 includes: a sealing land 34 configured to contact a face of a user and a compressible portion 28 extending away from the sealing land 34.

In one aspect, the face seal 12 further includes an edge portion 30 configured to receive at least a portion of the body 16 of the respiratory mask 10.

In one aspect, the face seal 12 further includes a main portion, the main portion including the sealing land 34. In one aspect, the face seal 12 further includes a chin retainment element 26, the chin retainment element 26 extending away from the main portion of the face seal 12 and being configured to receive at least a portion of chin of the user.

In one aspect, sealing land 34 has a free edge 36, the compressible portion 28 extending away from the sealing land 34 at a location between the free edge 36 and the chin retainment element 26.

In one aspect, the compressible portion 28 is transitionable between an uncompressed first condition and a compressed second condition, the sealing land 34 being configured to remain in contact with the face of the user when the compressible portion 28 transitions between the uncompressed first condition and the compressed second condition. In one aspect, the compressible portion 28 includes a proximal portion 40 joined to the sealing land 34, a distal portion 42 opposite the proximal portion 40, and a middle portion 44 therebetween. In one aspect, the middle portion 44 has a U-shaped cross section with a nadir 46. In one aspect, the nadir 46 is at a first location relative to the chin retainment element 26 when the compressible portion 28 is in the uncompressed first condition and the nadir 46 is at a second location relative to the chin retainment element 26 when the compressible portion 28 is in the compressed second condition, the second location being farther away from the chin retainment element 26 than the first location.

In one aspect, the compressible portion 28 is U-shaped in cross section.

In one aspect, the compressible portion 28 has a plurality of folds.

In one embodiment, a respiratory mask 10 comprises: a body 16; and a face seal 12 coupled to the body 16, the face seal 12 including: a main portion, the main portion including a sealing land 34 configured to contact a face of a user; a chin retainment element 26 extending away from the main portion of the face seal 12; a compressible portion 28, the compressible portion 28 having a proximal portion 40, a distal portion 42 opposite the proximal portion 40, and a middle portion 44 between the proximal and distal portions 40, 42, the proximal portion 40 joined to and extending away from the main portion of the face seal 12, the compressible portion 28 being between the sealing land 34 and the chin retainment element 26, the compressible portion 28 being transitionable between an uncompressed first condition and a compressed second condition; and an edge portion 30 joined to the distal portion 42 of the compressible portion 28, the edge portion 30 being configured to receive at least a portion of the body 16, the edge portion 30 being located a first distance from the main portion of the face seal 12 with the compressible portion 28 is in the uncompressed first condition and a second distance from the main portion of the face seal 12 when the compressible portion 28 is in the compressed second condition, the first distance being greater than the second distance.

In one aspect, the middle portion 44 of the compressible portion 28 has a first direction of curvature and each of the proximal portion 40 and the distal portion 42 of the compressible portion 28 has a second direction of curvature that is opposite the first direction of curvature.

In one aspect, the middle portion 44 of the compressible portion 28 is U-shaped in cross section. In one aspect, the compressible portion 28 has a nadir 46, the nadir 46 moving away from the chin retainment element 26 when the compressible portion 28 transitions from the uncompressed first condition to the compressed second condition.

In one aspect, the middle portion 44 has a bellows shape.

In one aspect, the sealing land 34 is configured to remain in contact with the face of the user when the compressible portion 28 transitions between the uncompressed first condition and the compressed second condition.

In one aspect, wherein the respiratory mask 10 is configured for use with a self-contained breathing apparatus (SCBA).

In one aspect, the face seal 12 is composed of at least one of silicone rubber, thermoplastic elastomer, and rubber.

In one embodiment, a face seal 12 for a respiratory mask 10 configured to be worn by a user comprises: a main portion, the main portion including a sealing land 34 configured to contact a face of a user; a chin retainment element 26 extending away from the main portion of the face seal 12; a compressible portion 28, the compressible portion 28 having a proximal portion 40, a distal portion 42 opposite the proximal portion 40, and a middle portion 44 between the proximal and distal portions 40, 42, the proximal portion 40 joined to and extending away from the main portion of the face seal 12, the middle portion 44 having a first direction of curvature and each of the proximal portion 40 and the distal portion 42 of the compressible portion 28 having a second direction of curvature that is opposite the first direction of curvature, the compressible portion 28 being between the sealing land 34 and the chin retainment element 26, the compressible portion 28 being transitionable between an uncompressed first condition and a compressed second condition, the sealing land 34 being configured to remain in contact with the face of the user when the compressible portion 28 transitions between the uncompressed first condition and the compressed second condition; and an edge portion 30 joined to the distal portion 42 of the compressible portion 28, the edge portion 30 being located a first distance from the main portion of the face seal 12 when the compressible portion 28 is in the uncompressed first condition and a second distance from the main portion of the face seal 12 when the compressible portion 28 is in the compressed second condition, the first distance being greater than the second distance.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope of the invention, which is limited only by the following claims.

What is claimed is:

1. A respiratory mask comprising:
a body; and
a face seal coupled to the body, the face seal including:
a sealing land configured to contact a face of a user; and
a compressible portion extending away from the sealing land.

2. The respiratory mask of claim 1, wherein the face seal further includes an edge portion configured to receive at least a portion of the body of the respiratory mask.

3. The respiratory mask of claim 1, wherein the face seal further includes a main portion, the main portion including the sealing land.

4. The respiratory mask of claim 3, wherein the face seal further includes a chin retainment element, the chin retainment element extending away from the main portion of the face seal and being configured to receive at least a portion of chin of the user.

5. The respiratory mask of claim 4, wherein the sealing land has a free edge, the compressible portion extending away from the sealing land at a location between the free edge and the chin retainment element.

6. The respiratory mask of claim 4, wherein the compressible portion is transitionable between an uncompressed first condition and a compressed second condition, the sealing land being configured to remain in contact with the face of the user when the compressible portion transitions between the uncompressed first condition and the compressed second condition.

7. The respiratory mask of claim 6, wherein the compressible portion includes a proximal portion joined to the sealing land, a distal portion opposite the proximal portion, and a middle portion therebetween.

8. The respiratory mask of claim 7, wherein the middle portion has a U-shaped cross section with a nadir.

9. The respiratory mask of claim 8 wherein the nadir is at a first location relative to the chin retainment element when the compressible portion is in the uncompressed first condition and the nadir is at a second location relative to the chin retainment element when the compressible portion is in the compressed second condition, the second location being farther away from the chin retainment element than the first location.

10. The respiratory mask of claim 1, wherein the compressible portion is U-shaped in cross section.

11. The respiratory mask of claim 1, wherein the compressible portion has a plurality of folds.

12. A respiratory mask comprising:
a body; and
a face seal coupled to the body, the face seal including:
a main portion, the main portion having a sealing land configured to contact a face of a user;
a chin retainment element extending away from the main portion of the face seal;
a compressible portion, the compressible portion having a proximal portion, a distal portion opposite the proximal portion, and a middle portion between the proximal and distal portions, the proximal portion joined to and extending away from the main portion of the face seal, the compressible portion being between the sealing land and the chin retainment element, the compressible portion being transitionable between an uncompressed first condition and a compressed second condition; and
an edge portion joined to the distal portion of the compressible portion, the edge portion being configured to receive at least a portion of the body, the edge portion being located a first distance from the main portion of the face seal when the compressible portion is in the uncompressed first condition and a second distance from the main portion of the face seal when the compressible portion is in the compressed second condition, the first distance being greater than the second distance.

13. The respiratory mask of claim 12, wherein the middle portion of the compressible portion has a first direction of curvature and each of the proximal portion and the distal portion of the compressible portion has a second direction of curvature that is opposite the first direction of curvature.

14. The respiratory mask of claim 12, wherein the middle portion of the compressible portion is U-shaped in cross section.

15. The respiratory mask of claim 14, wherein the compressible portion has a nadir, the nadir moving away from the chin retainment element when the compressible portion transitions from the uncompressed first condition to the compressed second condition.

16. The respiratory mask of claim 12, wherein the middle portion has a bellows shape.

17. The respiratory mask of claim 12, wherein the sealing land is configured to remain in contact with the face of the user when the compressible portion transitions between the uncompressed first condition and the compressed second condition.

18. The respiratory mask of claim 12, wherein the respiratory mask is configured for use with a self-contained breathing apparatus (SCBA).

19. The respiratory mask of claim 12, wherein the face seal is composed of at least one of silicone rubber, thermoplastic elastomer, and rubber.

20. A face seal for a respiratory mask configured to be worn by a user, the face seal comprising:
a main portion, the main portion including a sealing land configured to contact a face of a user;
a chin retainment element extending away from the main portion of the face seal;
a compressible portion, the compressible portion having a proximal portion, a distal portion opposite the proximal portion, and a middle portion between the proximal and distal portions, the proximal portion joined to and extending away from the main portion of the face seal, the middle portion having a first direction of curvature and each of the proximal portion and the distal portion of the compressible portion having a second direction of curvature that is opposite the first direction of curvature, the compressible portion being between the sealing land and the chin retainment element, the compressible portion being transitionable between an uncompressed first condition and a compressed second condition, the sealing land being configured to remain in contact with the face of the user when the compressible portion transitions between the uncompressed first condition and the compressed second condition; and
an edge portion joined to the distal portion of the compressible portion, the edge portion being located a first distance from the main portion of the face seal with the compressible portion is in the uncompressed first condition and a second distance from the main portion of the face seal when the compressible portion is in the compressed second condition, the first distance being greater than the second distance.
